(19) United States
(12) Patent Application Publication
(10) Pub. No.: US 2009/0201915 A1
(43) Pub. Date: Aug. 13, 2009

(54) INTERNET NETWORK COMMUNICATIONS SYSTEM AND A METHOD OF PUTTING A COMMUNICATIONS UNIT INTO COMMUNICATION WITH AN INTERNET NETWORK

(76) Inventors: Frederic Charrier, Issy-Les-Moulineaux (FR); Thierry Magnien, Villeparisis (FR); Loic Poilon, Joinville Le Pont (FR)

Correspondence Address: Muncy, Geissler, Olds & Lowe, PLLC, P.O. BOX 1364, FAIRFAX, VA, 22038-1364, US

(21) Appl. No.: 12/301,431

(22) PCT Filed: May 10, 2007
(86) PCT No.: PCT/FR2007/000787

§ 371 Date: Dec. 31, 2008

(30) Foreign Application Priority Data
May 19, 2006 (FR) 0604492

(51) Int. Cl. H04L 12/66

(52) U.S. Cl. 370/352

(57) ABSTRACT

A method of putting a communications unit into communication with an Internet network in which the communications unit calls the services platform, the services platform identifies the calling line, and an operating system is automatically installed in the communications unit enabling a connection to be provided with an Internet network and enabling navigation on the Internet network to be performed, and automatically enabling the operation of the operating system to be tracked and proceeding with updating and repair operations.

### BACKGROUND OF THE INVENTION

1. Field of the Invention

The present invention relates to an Internet communications system and to a method of putting a communications unit into communication with an Internet network.

2. Brief Description of the Related Art

An increasing number of users of the Internet are giving rise to telephone help problems in the event of the connection failing, particularly given the lack of experience of a large number of users, and dialog between the user and the technician providing telephone help is difficult, which means that that telephone calls for help are generally of long duration.

In addition, in present-say systems, a broadband Internet connection is generally made by connecting a communications unit firstly to a telecommunications exchange connected to an Internet network, and secondly to a computer that is configured by the user. Under certain circumstances, problems with the Internet connection come from the configuration of the user's computer without it being possible for the technician providing telephone help to obtain knowledge about this configuration, thereby further complicating the provision of telephone help, with such difficulties discouraging a certain number of potential users of the Internet.

An object of the invention is to provide an Internet communications system that minimizes operating needs not only when providing telephone help, but also for ordinary operation of the communications unit, and the invention also provides the corresponding method of putting a communications unit into communication with an Internet network.

### SUMMARY OF THE INVENTION

In order to achieve this object, the invention provides an Internet network communications system comprising an Internet network, a telecommunications exchange connected to the Internet network, and a communications unit connected to the telecommunications exchange, the communications unit including a central unit connected to a communications member for communicating with a telecommunications exchange, to a monitor, and to a keyboard-and-mouse assembly directly associated with the central unit, the central unit including non-volatile memory configured to enable dialog between the communications unit and a services platform in order to enable the services platform to install and monitor an operating system implanted in the central unit of the communications unit.

Thus, the communications unit includes all of the elements needed for providing an Internet connection such that dialog between the communications unit and the services platform enables overall and complete analysis to be performed of the system in the event of a problem that runs a risk of leading to an interruption in the Internet connection.

In an advantageous version of the invention, the communications unit includes a loudspeaker, and preferably also a microphone and a webcam. It is thus possible for the server to provide voice help, thereby enabling a repair action to be performed interactively in the event that a risk of breakdown is diagnosed.

According to another advantageous aspect of the invention, the system includes at least one additional module fitted with connector members corresponding to link members of the communications unit, for engaging therewith when an additional module is placed against the communications unit, and preferably, each additional module includes link members for connection with another additional module to enable connection with the communications unit merely by placing a plurality of additional modules beside one another and the communications unit. It is thus particularly easy to put an additional module into service.

The invention also provides a method of putting a communications unit into communication with a services platform via an Internet network associated with a telecommunications exchange to which the communications unit is connected by a line having an identification number, the method comprising the steps of the communications unit calling the services platform, and the services platform identifying the line and automatically installing an operating system in the communications unit, thereby enabling a connection to be provided with an Internet network and enabling navigation on the Internet network to be performed, and automatically enabling the operation of the operating system to be tracked and updating and repair operations to be performed.

Thus, while a communications unit is being put into service, it is possible immediately to implant an operating system in the communications unit, which operating system corresponds to the latest version in service, such that the connection with the services platform is provided under the best possible conditions. In addition, the continuous monitoring of the operation of the operating system enables operating anomalies to be detected and corrected even before an interruption occurs in the user's Internet connection. This considerably minimizes recourse to telephone help. In addition, the connection with the services platform enables applications to be run that remain implanted at least in part in the services platform, such that the communications unit can be fitted with a memory of small capacity, i.e. of low cost.

In an advantageous version of the method of the invention, it further includes the step of previously informing the services platform about the identification numbers of lines that are entitled to be put into communication, and of automatically recognizing the identification number of a line on receiving a call. This makes it possible for a user to install an Internet connection without the user performing any action other than connecting the communications unit to the line connected to the telecommunications exchange.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from description given hereinbelow and the accompanying figures, which are given by way of illustration only, and thus are not limitative of the present invention, and in which:

FIG. 1 is a diagrammatic representation of an Internet network communications system of the invention;

FIG. 2 is a diagrammatic representation of a flow chart implemented by the method of the invention; and

FIG. 3 is a diagrammatic perspective view of the communications unit and of an additional unit at the moment it is put into place.

### DETAILED DESCRIPTION OF THE PREFERRED EMBODIMENTS

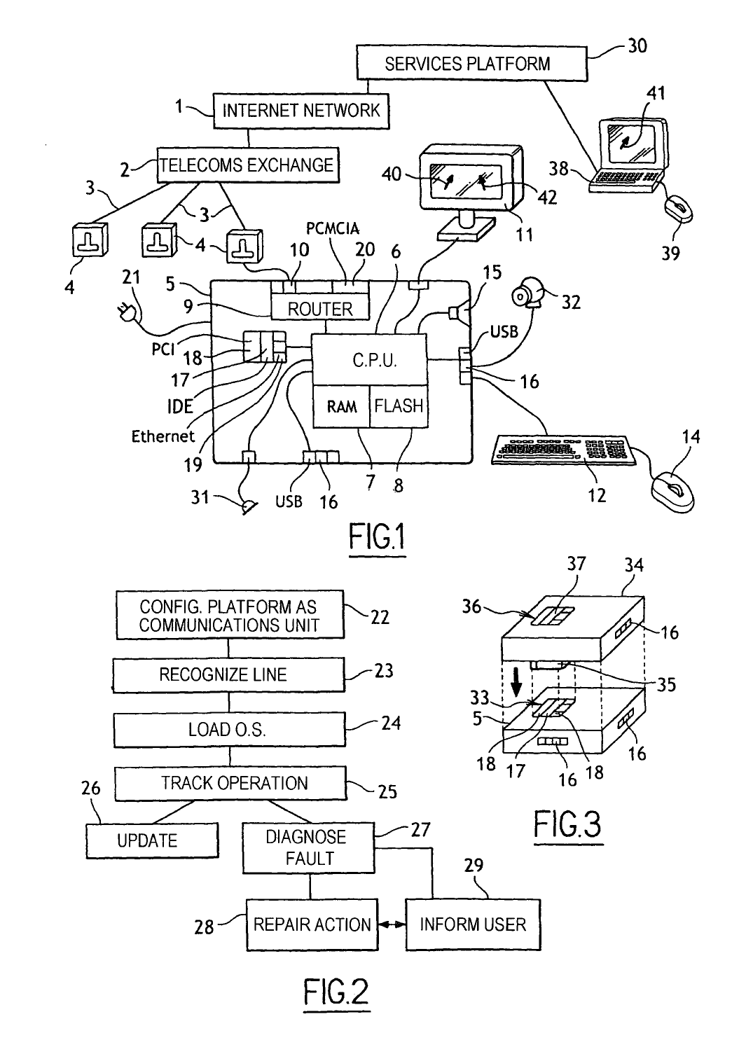

With reference to FIG. 1, the Internet network communications system of the invention comprises in known manner an Internet network 1 having connected thereto a telecommunications exchange 2 associated with telephone lines 3, each having a respective identification number and fitted with telephone outlets 4 enabling connections to be made with communications units 5, only one of which is shown in the figure.

According to the invention, the communications unit 5 comprises a central unit 6 including random access memory (RAM) 7 and non-volatile memory such as a flash memory 8. The central unit 6 is connected to an Internet network communications member such as a router 9 that is also contained in the communications unit and that is connected to the telephone line via a telecommunications outlet 10. The central unit is also directly associated with a monitor 11 and with an assembly comprising a keyboard 12 and a mouse 14.

In the preferred embodiment, as shown, the communications unit 5 also includes a loudspeaker 15, a microphone 31, and a webcam 32 that enable interactive intervention to take place, as explained below.

The communications unit preferably further includes link members for connecting with external pieces of equipment, in particular USB outlets 16, an IDE bus 17 for connecting a hard disk, a PCI bus 18 for connecting modules such as a graphics card or a PCI/USB converter, Ethernet outlets 19 for setting up a network with a computer or for installing an additional television module or an additional communications extension module, and a PCMCIA outlet enabling a wireless connection card to be installed for communication with corresponding elements, this list not being limiting.

With reference to FIG. 3, the communications unit 5 is preferably in the form of a module having an opening 33 in its top face giving access to the IDE bus 17, to the PCI bus 18, and to the Ethernet outlets 19. Correspondingly, an additional module 34 is fitted on its bottom face with projecting connector members 35 that engage with the link members of the control unit when the additional module is put into place against the control unit 5, as represented by the bold arrow in FIG. 3.

In the preferred embodiment shown, the additional module 34 itself includes in its top face an opening 36 giving access to link members 37 configured to receive connector members of a second additional module. Naturally, a suitable connection is established between the connector members 35 and the link members 37 to provide continuity of the functional connection between equipment contained in an additional module and the communications unit 5.

The communications unit is connected to the electrical power supply network via a power cord 21.

The system also has a services platform 30 that is connected firstly to the Internet network 1 and secondly to operator computers 38, only one of which is shown in the figure. Each operator computer 38 is fitted with a mouse 39.

With reference to FIG. 2, in the preferred implementation shown, the method of the invention comprises a first step 22 consisting in configuring the services platform 30 to store in its memory the identification numbers of lines that correspond to users authorized to access said Internet network. In parallel, the memory 8 of the communications unit 5 is loaded in the factory with a program that automatically establishes communication with the services platform when the communications unit 5 is put into service. When a call is made by the communications unit 5, the services platform 30 recognizes the line 3 and an authorized user is detected, whereupon the services platform 30 proceeds (24) to load an operating system into the memory 8 so as to give full access to the Internet network and enable applications to be run that may be contained in full or in part in the memory 8 or in the services platform 30 as a function of the available memory space. The operating system includes a self-diagnosis tool suitable for monitoring (25) the operation of the communications unit 5. In particular, when updates are performed (26) on the operating system, these updates are loaded automatically into the memory 8 so that the user always has the latest version of the operating system without needing to intervene in installing said latest version.

When the services platform detects (27) a breakdown or circumstances that might lead to a breakdown (e.g. a warning report from the self-diagnosis tool of the operating system), a repair action is launched (28) automatically. If the repair cannot be performed entirely automatically, information (29) about the action to be undertaken is sent to the user by means of a message that is either displayed on the monitor 11 or else communicated via the loudspeaker 15, and the effects of this action are automatically detected by the services platform 30, thereby enabling the repair to be undertaken interactively. If intervention by the operator is needed, the operator may ask the user for authorization to take complete control over the control unit 5 so that the operator can then use the operator computer 38 for processing the problem in full.

In an aspect of the invention, the user may be provided with remote training by causing a virtual pointer 40 to appear on the user's monitor 11, reproducing the position of the pointer 41 of the operator's mouse 39, and then requesting the user (e.g. by using the loudspeaker 15) to bring the pointer 42 of the user's mouse 14 to the same location as the virtual pointer 40 and then to click on the mouse in order to trigger the desired action. The results of this action can be monitored by the operator either by data being returned via the Internet network or by asking the user to point the webcam 32 to look at the monitor 11.

Naturally, the invention is not limited to the embodiment and the implementation described and variants can be applied thereto without going beyond the ambit of the invention as defined by the claims.

In particular, although the communications unit is described as having a central unit with non-volatile memory in the form of a flash memory, thereby enabling a communications unit to be made at very low cost while ensuring the connection to the Internet network in satisfactory manner, it is possible to provide communications units that are more sophisticated, including hard disks.

Although the method of the invention is described as including a prior step of configuring the services platform so as to inform it about the identification numbers of lines that are entitled to access the Internet network, with automatic recognition of the lines to which a communications unit 5 is connected, it is possible to provide for a message to be displayed when the communications unit 5 is put into service requesting the user to key in the number of the line and, where appropriate, a password enabling the connection to be established.

Although the invention is shown in FIG. 3 as having an additional module 34 that is stacked on the control unit 5, it is possible to make provision for additional modules to be placed beside the control unit or for additional modules to be inserted in housings within the control unit like cartridges in a games console.

It should also be observed that it is possible to connect an external piece of equipment to the control unit 5, either via an Ethernet connection, or via a wireless connection, so that the external piece of equipment can take advantage of some of the services provided by the services platform.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An Internet network communications system comprising an Internet network, a telecommunications exchange connected to the Internet network, and a communications unit connected to the telecommunications exchange, wherein the communications unit includes a central unit connected to a communications member for communicating with a telecommunications exchange, to a monitor, and to a keyboard-and-mouse assembly directly associated with the central unit, the central unit including non-volatile memory configured to enable dialog between the communications unit and a services platform in order to enable the services platform to install and monitor an operating system implanted in the central unit of the communications unit.

2. The Internet network communications system according to claim 1, wherein the communications unit includes a loudspeaker.

3. The Internet network communications system according to claim 1, wherein the communications unit includes link members for connecting to external pieces of equipment.

4. The Internet network communications system according to claim 3, including at least one additional module fitted with connector members corresponding to the link members of the communications unit, for engaging therewith when an additional module is placed against the communications unit.

5. The Internet network communications system according to claim 4, wherein each additional module includes link members for connection with another additional module to enable connection with the communications unit merely by placing a plurality of additional modules beside one another and the communications unit.

6. A method of putting a communications unit into communication with a services platform via an Internet network associated with a telecommunications exchange to which the communications unit is connected by a line shaving an identification number, wherein the method comprises the following steps:
the communications unit calling the services platform;
the services platform identifying the calling line; and
automatically installing an operating system in the communications unit thereby enabling a connection to be provided with an Internet network and enabling navigation on the Internet network to be performed, and automatically enabling the operation of the operating system to be tracked and updating and repair operations to be performed.

7. The method according to claim 6, including the steps of previously informing the services platform of the identification numbers of lines entitled to request being put into Internet network communication, and of automatically recognizing the identification number of the calling line when a communications unit is put into service.

8. The method according to claim 6, including a step of performing interactive repair by informing a user about an action to be carried out and by monitoring the effects of the action performed.

9. The method according to claim 8, wherein the action to be carried out is explained to the user by causing a virtual pointer to appear on the user's monitor, and having the user reproduce the movements thereof.

10. The method according to claim 6, including the step of giving complete control over the communications unit to an external operator.

11. Internet network communications system according to claim 2, wherein the communications unit also includes at least one of a microphone and a webcam.
